(19) United States
(12) Patent Application Publication
(10) Pub. No.: US 2022/0154492 A1
(43) Pub. Date: May 19, 2022

(54) Smart Door Opening System

(71) Applicants: Azariah Keith, Freedom, IN (US); Jennifer Keith, Freedom, IN (US)

(72) Inventors: Azariah Keith, Freedom, IN (US); Jennifer Keith, Freedom, IN (US)

(21) Appl. No.: 17/525,865

(22) Filed: Nov. 13, 2021

Related U.S. Application Data
(60) Provisional application No. 63/114,101, filed on Nov. 16, 2020.

(51) Int. Cl. E05B 47/00; E05F 15/00; G07C 9/00

(52) U.S. Cl. CPC E05B 47/0046; E05F 15/00; G07C 9/00309; E05B 2047/0091; G07C 2009/00325; E05Y 2400/40; E05Y 2400/85; E05Y 2900/132; E05Y 2800/70; E05B 2047/0054

(57) ABSTRACT

A smart door opening system includes a latch opening mechanism configured to be received in a latch hole of a door frame and configured to push a latch of a door out of the latch hole and a hinge opening mechanism configured to move the door from a closed position to an open position. A controller is operably coupled to the latch opening mechanism and the hinge actuator. The controller is configured to cause the latch opening mechanism to push the latch out of the latch hole and the hinge opening mechanism to move the door from the closed position to the open position in response to receiving a door open signal. The system includes a network interface configured to receive the door open signal via a network, and to communicate the door open signal to the controller.

### CROSS-REFERENCE TO RELATED APPLICATIONS

This application claims priority to U.S. Provisional Application Ser. No. 63/114,101 entitled “Smart Door Opening System” by Keith et al., filed Nov. 16, 202, the disclosure of which is hereby incorporated herein by reference in its entirety.

### TECHNICAL FIELD

The disclosure relates generally to doors, and, in particular, to systems and methods of opening doors.

### BACKGROUND

Door opening systems are known that enable doors to be opened and closed remotely. However, door opening systems that work with standard doors for homes and building, e.g., having latches that are received in a latch hole in a door frame and standard hinges, e.g., butt hinges, and that can be easily retrofitted or installed in existing doors or door frames are generally not known.

### SUMMARY

According to one embodiment, a smart door opening system includes a latch opening mechanism configured to be received in a latch hole of a door frame and configured to push a latch of a door out of the latch hole. The system also includes a hinge opening mechanism having a hinge configured to attach to an edge of a door and a door frame to allow the door to move between an open position at which the door is open and a closed position at which the door is closed with respect to the door frame, and a hinge actuator configured to move the hinge between the open position and the closed position. The system also includes a controller operably coupled to the latch opening mechanism and the hinge actuator. The controller is configured to cause the latch opening mechanism to push the latch out of the latch hole and the hinge actuator to move to the hinge from the closed position to the open position in response to receiving a door open signal. A network interface is configured to receive the door open signal via a network, and to communicate the door open signal to the controller.

According to another embodiment, a smart door system includes a door including a latch and a door frame defining a latch hole configured to receive the latch. The system includes a smart door opening system configured to open and close the door with respect to the door frame. The smart door opening system includes a latch opening mechanism received in the latch hole and configured to push the latch out of the latch hole. The smart door opening system also includes a hinge opening mechanism having a hinge configured to attach to an edge of the door and to the door frame and configured to allow the door to move between an open position at which the door is open and a closed position at which the door is closed with respect to the door frame, and a hinge actuator configured to move the hinge between the open position and the closed position. A controller is operably coupled to the latch opening mechanism and the hinge actuator. The controller is configured to cause the latch opening mechanism to push the latch out of the latch hole and the hinge actuator to move the hinge from the closed position to the open position in response to receiving a door open signal. A network interface is configured to receive the door open signal via a network, and to communicate the door open signal to the controller.

### BRIEF DESCRIPTION OF THE DRAWINGS

FIG. 1 is a schematic depiction of an embodiment of a smart door opening system according to the present disclosure.

FIG. 2 is a schematic depiction of the latch opening mechanism of the smart door opening system of FIG. 1 in the retracted position.

FIG. 3 is a schematic depiction of the latch opening mechanism of the smart door opening system of FIG. 1 in the extended position.

FIG. 4 is a schematic depiction of the actuator of the smart door opening system of FIG. 1 in the closed position.

FIG. 5 is a schematic depiction of the actuator of the smart door opening system of FIG. 1 in the open position.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to a person of ordinary skill in the art to which this disclosure pertains.

The present disclosure is directed to a smart door and smart door opening system that enables a door to be opened and closed remotely and that can easily be retrofitted for use with an existing door and can be programmed to activate the opening or closing of the door either remotely, automatically by a voice command, and is integrated with a wireless communication network to enable smart and remote control of the system.

According to one embodiment a smart door opening system 10 is provided that includes a latch opening mechanism 18, hinge opening mechanisms 14, a controller 22, a network interface 24, and a remote device 28, 30. The system 10 is configured for use with a standard door 12 of a home or building that is mounted to a door frame with hinges and includes a latch 16 that is received in a latch hole in the door frame.

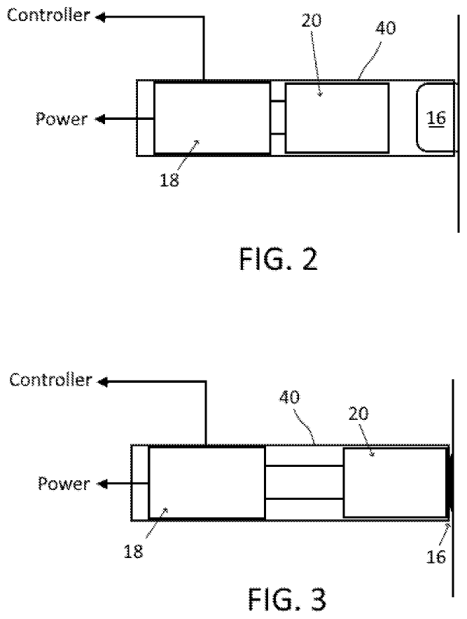

Referring to FIGS. 2 and 3, the latch opening mechanism 18 includes a latch pusher 20 and a latch pusher actuator 18. The latch pusher actuator 18 and latch pusher 20 are received in a latch hole 40 formed in the door frame. The latch hole 40 is positioned to receive the latch 16 when the door 12 is in a closed position. The latch pusher actuator 18 includes an actuator, such as a motor, configured to move the latch pusher 20 axially within the latch hole toward and away from the latch hole opening. In particular, the motor 18 is configured to move the latch pusher 20 from a retracted position (FIG. 2) to an extended position (FIG. 3). When the latch pusher 20 is in the extended position, the distal end of the latch pusher 20 is recessed within the latch hole opening far enough to allow the latch 16 to be received in the latch hole 40, as depicted in FIG. 2. When the latch pusher 20 is in the extended position, the distal end of the latch pusher 20 is approximately flush with the surface of the door frame or strike plate surrounding the latch hole 40. The extended position of the latch pusher is used to push the latch 16 out of the latch hole 40 to enable the door to be opened as depicted in FIG. 3.

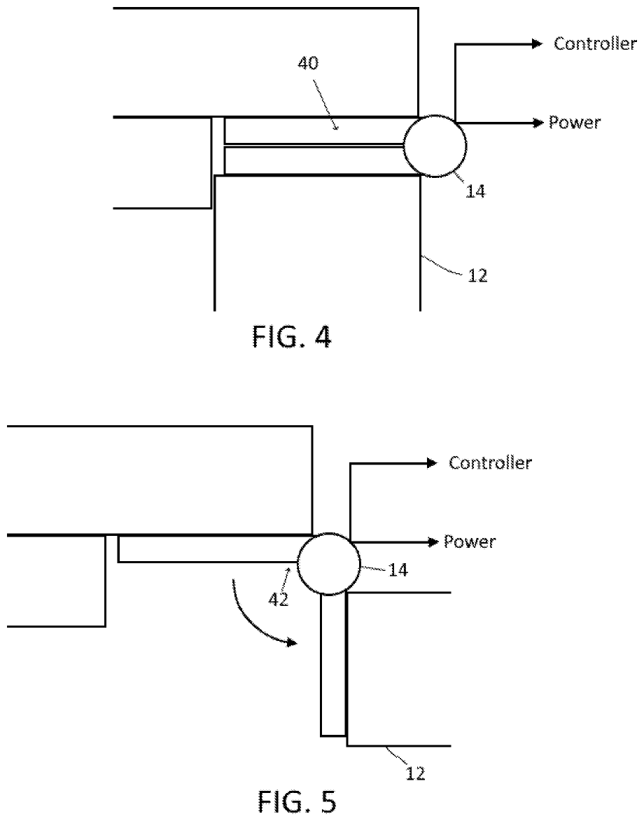

The hinge opening mechanism 15 includes a hinge and a hinge actuator. The hinge is configured to attach to an edge of the door and to the door frame and to allow the door to move between an open position at which the door is open and a closed position at which the door is closed with respect to the door frame. The hinge actuator comprises a motor that is configured to move the hinge between the open position and the closed position. In one embodiment, the hinge actuator is operably connected to the respective flanges of the hinge(s) 42 to cause the opening and closing of the door by manipulating the hinge. As depicted in FIGS. 4 and 5, the hinge actuator 14 is configured to cause the hinge to move the door between a closed position (FIG. 4) and an open position (FIG. 5).

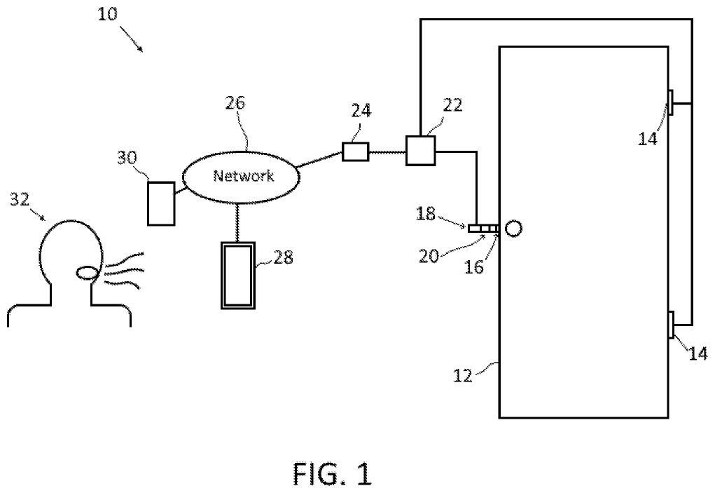

Referring again to FIG. 1, the latch opening mechanism 18 and the hinge opening mechanism 14 are electrically connected to the controller 22. In embodiments, the controller 22 is a microprocessor, microcontroller, programmable logic device such as a Field Programmable Gate Array (FPGA), logic circuitry, an integrated circuit, an Application Specific Integrated Circuit (ASIC) or module, or any combination thereof. The controller 22 includes or has access to a memory (not shown), such as but not limited to persistent or non-volatile memory, volatile memory, or a combination thereof. Programmed instructions are stored in the memory for execution by the controller. The programmed instructions include instructions for enabling the controller to control the operation of the latch opening mechanism and the actuator for the door hinge(s), as well as to send and receive communication signals via the network interface to cause the door to open and close. The signals may include instructions received from an external device 28, 30 via the network 26.

The wireless network interface 24 is provided to enable bi-directional communication between the controller 22 and one or more external devices 28, 30 over a wireless network 26. In various embodiments, the external device(s) may include a voice-activated personal digital assistant 30 (e.g., Alexa by Google, Amazon Echo, Apple Siri, etc.), and an application running on a computing device 28 (e.g., smart phone, tablet computer, laptop or desktop computer, etc.). Voice commands and/or command inputs received on a remote device may be used to control the opening and closing of the door. When a voice command and/or a command input is received at the controller 22 via the network 26, the controller 22 is configured to control the operation of the door opening system 10 to cause the door to open or close.

In one embodiment, the controller 22 is configured to cause the latch opening mechanism 18 to push the latch of the door out of the latch hole of the door frame (FIG. 3) and to cause the hinge actuator of the hinge opening mechanism 14 to move the hinge from the closed position (FIG. 4) to the open position (FIG. 5) in response to receiving a door open signal. The network interface 24 is configured to receive the door open signal via the network 26 and to communicate the door open signal to the controller 22. The remote device 28,30 is configured to generate the door open signal and to transmit the door open signal to the network 26 where it is received by the network interface 24 and communicated to the controller 22. The remote device 28, 30 may be configured to generate the door open signal in response to receiving a voice command from a user of the remote device.

The smart door opening system 10 may also be configured to enable the door to be closed remotely. For example, the controller 22 may be configured to cause the latch opening mechanism, e.g., the latch pusher, to be moved to the retracted position (FIG. 2) so the latch may be received in the latch hole and to cause the hinge actuator of the hinge opening mechanism 14 to move the hinge to the closed position (FIG. 4) in response to receiving a door close signal. The network interface 24 is configured to receive the door close signal via the network 26 and to communicate the door close signal to the controller 22. The remote device 28, 30 is configured to generate the door open signal and to transmit the door open signal to the network 26 where it is received by the network interface 24 and communicated to the controller 22. The remote device 28, 30 may be configured to generate the door open signal in response to receiving a voice command from a user of the remote device.

The smart door opening system 10 may be provided as part of a smart door system. The smart door system includes a door having a latch and a door frame defining a latch hole for receiving the latch. The smart door system includes a smart door opening system as described above.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A smart door opening system comprising:
a latch opening mechanism configured to be received in a latch hole of a door frame and configured to push a latch of a door out of the latch hole;
a hinge opening mechanism including:
a hinge configured to attach to an edge of a door and a door frame to allow the door to move between an open position at which the door is open and a closed position at which the door is closed with respect to the door frame; and
a hinge actuator configured to move the hinge between the open position and the closed position;
a controller electrically connected to the latch opening mechanism and the hinge actuator, the controller being configured to cause the latch opening mechanism to push the latch out of the latch hole and the hinge actuator to move to the hinge from the closed position to the open position in response to receiving a door open signal; and
a network interface configured to receive the door open signal via a network, and to communicate the door open signal to the controller.

2. The smart door opening system of claim 1, further comprising:
a remote device configured to connect to the network and configured to generate the door open signal.

3. The smart door opening system of claim 2, wherein the remote device is one of a smart phone, tablet, and computer.

4. The smart door opening system of claim 2, wherein the remote device is configured to receive a voice command from a user, and
wherein the remote device is configured to generate the door open signal in response to receiving the voice command.

5. The smart door opening system of claim 1, wherein the network is a wireless network.

6. The smart door opening system of claim 1, wherein the latch opening mechanism includes:
a latch pusher configured to move between an extended position at which the latch is pushed out of the latch hole and a retracted position at which the latch is allowed to extend into the latch hole; and
a latch pusher actuator configured to move the latch pusher between the retracted position and the extended position,
wherein the controller is operably coupled to the latch pusher actuator and to cause the latch pusher actuator to move the latch pusher from the retracted position to the extended position in response to receiving the door open signal.

7. The smart door opening system of claim 6, wherein the controller is configured to cause the latch pusher actuator to move the latch pusher to the retracted position and to cause the hinge actuator to move to the closed position in response to receiving a door close signal, and
wherein the network interface is configured to receive the door close signal via the network, and to communicate the door close signal to the controller.

8. A smart door system comprising:
a door including a latch;
a door frame defining a latch hole configured to receive the latch; and
a smart door opening system including:
a latch opening mechanism received in the latch hole and configured to push the latch out of the latch hole;
a hinge opening mechanism including:
a hinge configured to attach to an edge of the door and to the door frame and configured to allow the door to move between an open position at which the door is open and a closed position at which the door is closed with respect to the door frame; and
a hinge actuator configured to move the hinge between the open position and the closed position;
a controller electrically connected to the latch opening mechanism and the hinge actuator, the controller being configured to cause the latch opening mechanism to push the latch out of the latch hole and the hinge actuator to move the hinge from the closed position to the open position in response to receiving a door open signal; and
a network interface configured to receive the door open signal via a network, and to communicate the door open signal to the controller.

9. The smart door system of claim 8, further comprising:
a remote device configured to connect to the network and configured to generate the door open signal.

10. The smart door system of claim 9, wherein the remote device is one of a smart phone, tablet, and computer.

11. The smart door system of claim 9, wherein the remote device is configured to receive a voice command from a user, and
wherein the remote device is configured to generate the door open signal in response to receiving the voice command.

12. The smart door system of claim 8, wherein the network is a wireless network.

13. The smart door system of claim 8, wherein the latch opening mechanism includes:
a latch pusher configured to move between an extended position at which the latch is pushed out of the latch hole and a retracted position at which the latch is allowed to extend into the latch hole; and
a latch pusher actuator configured to move the latch pusher between the retracted position and the extended position,
wherein the controller is operably coupled to the latch pusher actuator and to cause the latch pusher actuator to move the latch pusher from the retracted position to the extended position in response to receiving the door open signal.

14. The smart door system of claim 8, wherein the controller is configured to cause the latch pusher actuator to move the latch pusher to the retracted position and to cause the hinge actuator to move the hinge to the closed position in response to receiving a door close signal, and
wherein the network interface is configured to receive the door close signal via the network, and to communicate the door close signal to the controller.
